(19) United States
(12) Patent Application Publication
(10) Pub. No.: US 2019/0126815 A1
(43) Pub. Date: May 2, 2019

(54) METHOD FOR CONTROLLING THE AUTOMATIC DISPLAY OF A PICTOGRAM REPRESENTATIVE OF THE IMMINENT OPENING OF A DOOR

(71) Applicant: VALEO VISION, Bobigny Cedex (FR)

(72) Inventors: Xavier MOREL, Bobigny Cedex (FR); Didier GIRAULT, Bobigny Cedex (FR)

(73) Assignee: VALEO VISION, Bobigny Cedex (FR)

(21) Appl. No.: 16/091,261

(22) PCT Filed: Apr. 5, 2017
(86) PCT No.: PCT/EP2017/058146

§ 371 Date: Oct. 4, 2018

(30) Foreign Application Priority Data
Apr. 5, 2016 (FR) 1652973

(51) Int. Cl. B60Q 1/50; B60Q 1/52; G09G 5/00; G08G 1/16

(52) U.S. Cl. CPC B60Q 1/50; B60Q 1/525; E05B 81/77; G09G 2380/10; G08G 1/168; B60Q 2400/00; E05Y 2900/531; G09G 5/003

(57) ABSTRACT

A method for controlling a display means on board a motor vehicle, characterized in that it includes: a first step of determining the imminent opening of a door, during which it is checked that at least one parameter representative of the imminent opening of a door of the motor vehicle fulfils at least one predetermined condition, a second step of developing a display order that is triggered when the predetermined conditions are fulfilled, and during which an order to display a pictogram representative of the imminent opening of a door on the display means is emitted by an electronic control unit.

### TECHNICAL FIELD OF THE INVENTION

The invention relates to a method for controlling a display means on board a motor vehicle, the display means including a display area visible from outside the vehicle, the display means being configured to selectively display each of the pictograms from a list of a plurality of predetermined to pictograms, each predetermined pictogram being representative of a determined situation.

### TECHNICAL BACKGROUND OF THE INVENTION

When an occupant of a motor vehicle wishes to get out of the vehicle, he has to pay attention so that no other road users, for example a bicycle, a pedestrian or a vehicle, are liable to be inconvenienced or struck when his door is opened. This attention is particularly necessary when the door to be opened is situated on the side of the road, but it is also preferable to pay attention so as not to collide with a pedestrian when the door is situated on the side of a pavement.

Some motor vehicles include doors that are equipped, on the inside wall thereof, with visual means, for example reflective strips or lights, so as to allow a road user to see an open door from afar, in particular in poor ambient lighting conditions, for example at night.

However, these visual means allow the door to be seen once it is open, but they do not allow a road user to anticipate the opening of a closed door.

Vehicles do not have any signalling means that make it possible to warn of the imminent opening of a door. Vigilance when opening the door is thus entirely down to the occupants of the vehicle. Now, in some situations, it may be the case that the occupant of the vehicle does not employ the vigilance necessary to avoid accidents. This is the case in particular when a child actuates the door in order to get out without paying attention.

### BRIEF SUMMARY OF THE INVENTION

In order in particular to solve the abovementioned problems, the invention proposes a control method of the type described above, characterized in that the method includes:
a first step of determining the imminent opening of a door of the vehicle, during which it is checked that at least one parameter representative of the imminent opening of a door of the motor vehicle fulfils at least one predetermined condition;
a second step of developing a display order that is triggered when the predetermined conditions are fulfilled, and during which an order to display a pictogram representative of the imminent opening of a door of the vehicle on the display means is emitted by an electronic control unit.

According to other features of the invention:
a parameter representative of the imminent opening of a door of the vehicle is formed by the speed of the vehicle, an associated condition to be fulfilled in the first step being that the speed of the vehicle is zero;
a parameter representative of the imminent opening of a door of the vehicle is formed by the operating state of the engine of the vehicle, an associated condition to be fulfilled in the first step being that the engine changes from the turned-on state to the turned-off state;
a parameter representative of the imminent opening of a door of the vehicle is formed by the time that has elapsed since an engine of the vehicle was turned off, an associated condition to be fulfilled in the first step being that a time delay has been exceeded, starting from the turning off of the engine of the vehicle;
the motor vehicle includes a sensor for sensing the presence of a hand of an occupant of the vehicle close to or in contact with an interior control element for opening the door, a fourth parameter representative of the imminent opening of a door of the vehicle being formed by the presence of a hand close to or in contact with the interior opening control element, an associated condition to be fulfilled in the first step being the presence of a hand close to the interior opening control element being detected;
the presence sensor is formed by at least one camera;
the presence sensor is formed by at least one infrared sensor arranged close to the interior opening control element;
the presence sensor is formed by at least one capacitive sensor arranged close to the interior opening control element;
a parameter representative of the imminent opening of a door of the vehicle is formed by the buckle state of a safety belt fitted in the vehicle, an associated condition to be fulfilled in the first step being that the safety belt changes from a buckled state to an unbuckled state;
a parameter representative of the imminent opening of a door of the vehicle is formed by the detection of an occupant on his seat, an associated condition to be fulfilled in the first step being that a weight greater than a determined threshold is detected on said seat;
a parameter representative of the imminent opening of a door of the vehicle is formed by the locking state of a lock of at least one door, an associated condition to be fulfilled in the first step being that the lock of at least one door changes from a locked state to an unlocked state;
the vehicle is equipped with a geolocation device into which the driver is able to enter at least one destination determined by the driver, a parameter representative of the imminent opening of a door of the vehicle being formed by the geographical location, detected by the geolocation device, of the vehicle, an associated condition to be fulfilled in the first step being that the vehicle has reached the determined destination;
the vehicle is equipped with an automatic parking assistance device, a parameter representative of the imminent opening of a door of the vehicle being formed by the actuation of the parking assistance device, an associated condition to be fulfilled in the first step being that the parking assistance device has been actuated;
the motor vehicle includes two display means that are each arranged on a side of the vehicle, at least one of the parameters representative of the imminent opening of a door of the vehicle being able to detect the side on which the door whose opening is imminent is situated, the display order developed in the second step being sent only to the display means arranged on the same side as said door whose imminent opening was detected in the first step.
the rear of the motor vehicle includes a single display means;
the motor vehicle includes at least one display means that is arranged on the side and/or at the front of the vehicle.

The invention also relates to a system for displaying at least one pictogram on a motor vehicle, comprising:
a display means comprising a display area intended to be arranged on the vehicle so as to be visible from outside the vehicle;
at least one device for detecting parameters representative of the imminent opening of a door of the vehicle;
an electronic control unit for controlling the display means and that is connected to the detection device and to the display means in order to be able to control the display of a pictogram representative of the imminent opening of a door of the vehicle on the basis of the detected parameters representative of the opening of a door of the vehicle.

According to another feature of the display system, each device for detecting parameters representative of the imminent opening of a door of the vehicle is chosen from the following list:
a speed sensor of the vehicle;
a manual control element for turning off an engine of the vehicle;
a timer measuring the time that has elapsed starting from the turning off of the engine of the vehicle;
a sensor for sensing the presence of a hand of an occupant of the vehicle close to or in contact with an interior control element for opening a door;
a device for detecting the buckle state of a safety belt fitted in the vehicle;
a sensor for sensing the presence of an occupant on a seat of the vehicle;
a geolocation device of the vehicle;
an automatic parking assistance device of the vehicle.

The invention also relates to a motor vehicle comprising a display system produced according to the teaching of the invention.

### BRIEF DESCRIPTION OF THE FIGURES

Further features and advantages of the invention will become apparent from reading the following detailed description, for an understanding of which reference is made to the appended drawings, in which:

FIG. 1 is a rear view that schematically shows a vehicle equipped with two signalling devices for displaying pictograms and that are able to apply the method carried out according to the teaching of the invention,

FIG. 2 is a detailed view that schematically shows a signalling device for displaying pictograms,

FIG. 3 is a perspective view that schematically shows one embodiment of the display means according to the invention,

FIG. 4 is a plan view that schematically shows the display means of FIG. 3,

FIGS. 5A to 5E show examples of pictograms able to be displayed by the display means of the vehicle, the pictogram of FIG. 5D being particularly representative of a situation of the imminent opening of a door of the vehicle;

FIG. 6 is a diagram that shows one embodiment of the invention implementing an electronic control unit for controlling the display means on the basis of data supplied by sensors on board the vehicle;

FIG. 7 is a plan view that schematically shows a motor vehicle passenger compartment equipped with sensors that are intended to measure parameters representative of the imminent opening of a door;

FIG. 8 is a block diagram that illustrates the steps of the method carried out according to the teaching of the invention.

### DETAILED DESCRIPTION OF THE FIGURES

In the rest of the description, elements having an identical structure or similar functions will be denoted by the same references.

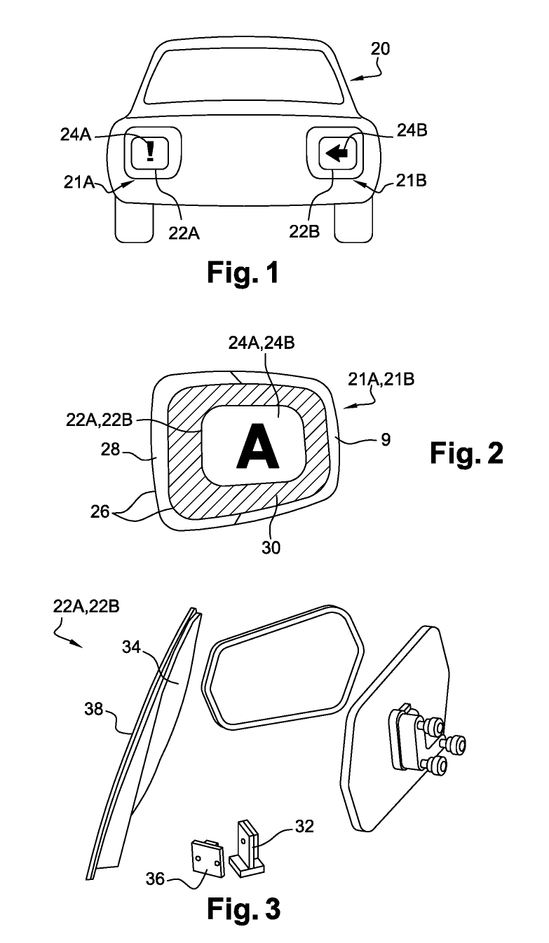

FIG. 1 shows a vehicle with an on-board display means. This display means includes a display area visible to third parties from outside the vehicle.

In the example shown in FIG. 1, the vehicle 20 is equipped with two signalling lighting devices 21A, 21B including pictogram display means 22A, 22B. Each display means 22A, 22B comprises a display area 24A, 24B arranged at the rear of the vehicle 20, substantially at the location where a rear signalling light is normally positioned. Thus, a first display means 22A is arranged on the left-hand side of the vehicle 20, whereas a second display means 22B is arranged on the right-hand side of the vehicle 20.

In one variant, not shown, the motor vehicle includes a single display means that is arranged at the rear.

According to another variant, not shown, the motor vehicle includes at least one display means that is arranged on the side and/or at the front of the vehicle. This variant may be combined with the presence of at least one display means at the rear of the vehicle.

The role of the display means 22A, 22B is to display pictograms in luminous form on the display area 24A, 24B. The display area 24A, 24B thus has a surface illuminated in accordance with the form of the pictogram, said illuminated surface emitting a light beam called a “pictogram beam”.

The pictograms may be used to contribute to a regulatory signalling function. They may also be used independently of the use of a regulatory signalling function.

The regulatory photometric characteristics of signalling lights, such as position lights, direction indicator lights, stop lights or fog lights, are well defined. They relate in particular to the minimum and maximum luminous intensity ranges to be complied with, the visibility angle of the beam, the colour of the beam, the surface area of the lighting surface of the function, or else the minimum distance between different functions.

When the display of the pictogram is used to perform a regulatory signalling function, the signalling device 21A, 21B may be produced in accordance with two embodiments.

In a first embodiment of the signalling device 21A, 21B, shown in FIG. 1, the display means 22A, 22B are configured such that the pictogram beam is able on its own to fulfil the regulatory photometric characteristics of a defined signalling function. In this embodiment, the display means is thus designed to display pictograms that are parameterized so as to emit a pictogram light beam that complies with all of the regulatory requirements of a particular signalling function.

A single pictogram may in particular fulfil a plurality of functions at the same time or alternately, such as for example an indicator light and a position light. A plurality of pictograms may also be displayed at the same time or alternately, each pictogram fulfilling the photometric characteristics of a different function of the signalling light.

Preferably and advantageously, the signalling function achieved with certain pictograms is a position light function or a combined lamp and stop light function.

In a second embodiment of the signalling device 21A, 21B shown in FIG. 2, the device 21A, 21B comprises additional signalling means 26. These additional means 26 are intended to provide an additional beam that is added to the pictogram beam produced by the display means. The combination of the additional beam and the beam of the pictogram makes it possible to produce an overall light beam that achieves the regulatory photometric characteristics that are not fulfilled entirely by the pictogram beam on its own. The additional means 26 are equipped with at least one additional area 28, 30, in this case two of them, which are each able to transmit an additional light beam. Thus, by virtue of the additional means 26, the signalling device 21A, 21B provides an overall light beam that fulfils the regulatory photometric characteristics.

The additional means 26 are for example lighting devices used for normal signalling light functions and that are independent of the display means 22A, 22B. They comprise a light source able to emit light rays, for example one or more light-emitting diodes, and means for distributing the light rays onto the additional area 28, 30, the additional area 28, 30 transmitting the light rays by forming the additional beam. The distribution means may be a light guide or a reflector.

When a pictogram appears or it changes shape, the additional means 26 provide the appropriate additional beam substantially simultaneously, for example so as to increase the visibility angle and/or the luminous surface area of the overall beam.

As illustrated in the embodiment of FIG. 2, the signalling device 21A, 21B may comprise a plurality of additional means 26, in this case two of them, one per function. The two additional areas 28, 30 are arranged at least partly around the display area 24A, 24B of the pictogram. An adjacent additional first area 30 surrounds the display area 24A, 24B and serves to complement the position light function—possibly in combination with a stop function. A second additional area 28 partly surrounds the first additional area 30 and serves to complement the direction indicator function (indicator light). Furthermore, a reflector 9 completes the whole of the first additional area 30.

Regardless of the embodiment chosen for the signalling device 21A, 21B, the display means is designed to display a detailed pictogram that is clearly visible to a road user, both at night and during the day. Without limitation, four exemplary embodiments of such display means 22A, 22B are described hereinafter.

According to a first embodiment of the display means 22A, 22B, not shown in the figures, each display means is a liquid-crystal, plasma or light-emitting diode screen, the display area 24A, 24B of the signalling device 21A, 21B being that of the screen.

According to a second embodiment of the display means 22A, 22B, not shown in the figures, the display means 22A, 22B comprise an areal light guide including groups of prism-type structures or cavities on one of its lateral faces. The structures are designed to return light selectively injected via one of the edges to an opposite face. There is thus a screen having areas illuminated selectively via the edges. This type of display is described for example in documents FR2994248 and US2013314944.

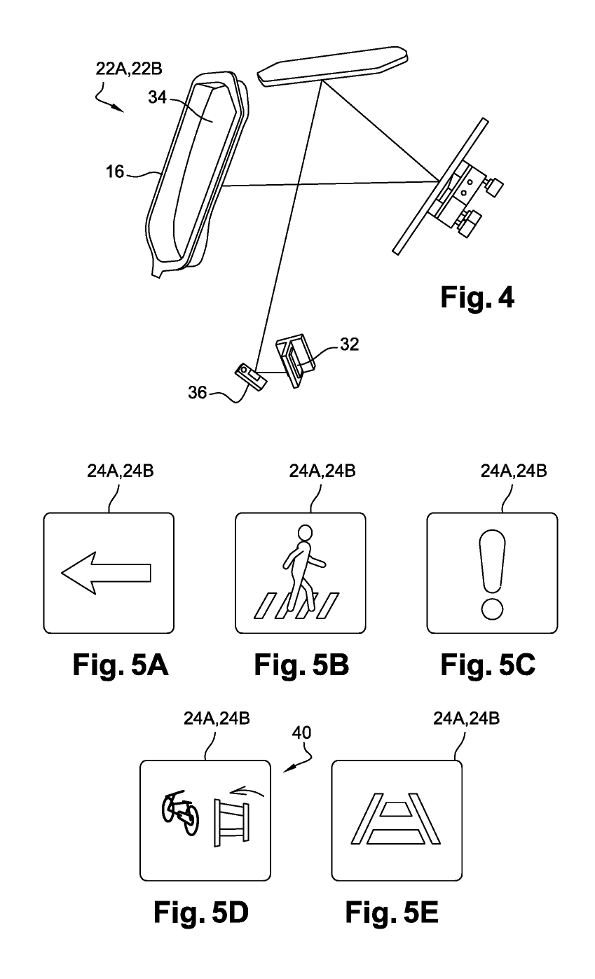

According to a third embodiment of the display means 22A, 22B shown in FIGS. 3 and 4, the display means 22A, 22B comprise at least one laser source 32, for example a laser diode with or without a photoluminescent element, able to form a laser beam, a transmission surface 34 defining the display area 24A, 24B, and scanning means 36 configured to scan the transmission surface 34 with the laser beam. The transmission surface 34 is for example arranged on a closing outer lens 38 of the light. The laser beam that comes from the laser source 32 is intended to illuminate the transmission surface 34.

The laser beam projects a luminous trace, in the shape of a point, onto the transmission surface 34. The scanning of the luminous trace is performed by the scanning means 36 at a speed high enough that the human eye does not see its movement over the transmission surface 34.

In this case, the scanning means 36 are a mobile micromirror that makes it possible to scan the transmission surface 34 by reflecting the laser beam. The micromirrors mentioned as scanning means are, for example, of MEMS (microelectromechanical system) type. However, the invention is in no way limited to this scanning means, and may use other types of scanning means, such as a series of mirrors arranged on a rotary element, the rotation of the element causing the transmission surface to be scanned by the laser beam.

The scanning of the laser beam by the scanning means 36 allows pictograms to appear on the transmission surface 34, the scanning means 36 being controlled by a control unit, for example.

According to a fourth embodiment of the display means, not shown, the display means comprise at least one light source formed of at least one light-emitting diode, a transmission surface defining the display area, and an array of micromirrors configured to reflect the light rays coming from the at least one light source towards the transmission surface. The transmission surface is for example arranged on the closing outer lens of the light or else is formed by a translucent screen situated behind this closing outer lens. The light beam that comes from the light source is intended to illuminate the transmission surface.

In this last embodiment, the display means comprise an array of micromirrors (also known under the acronym DMD for digital micromirror device), which directs the light rays by reflection. The light rays are reflected in two possible directions: either towards the focusing optical system or in a direction other than the focusing optical system.

Regardless of the embodiment of the display means, the latter is configured to selectively display each of the pictograms from a list of a plurality of predetermined pictograms, each predetermined pictogram being representative of a determined situation. FIGS. 5A to 5E show a few examples of pictograms able to be displayed alternately on the display area 24A, 24B, and two types of which are distinguished between, for example.

Generally, a pictogram is a graphical sign representative of a situation whose meaning is able to be understood quickly. The pictogram includes a stylized figurative drawing and/or alphanumeric symbols.

Some pictograms warn of an emergency or hazardous situation, for example a directional arrow as illustrated in FIG. 5A, a pedestrian crossing in front of the vehicle as illustrated in FIG. 5B, an exclamation mark warning of a hazard as illustrated in FIG. 5C, a warning of an opening door as illustrated in FIG. 5D, or else a warning to comply with the safe distance as illustrated in FIG. 5E. Hereinafter, the invention will relate more particularly to a method for displaying the pictogram representative of the imminent opening of a door of the vehicle, one example of which is illustrated in FIG. 5D and which will be denoted by the reference 40 in the remainder of the description.

The display of some pictograms may be dynamic, by modifying the size thereof, the movement thereof and the flashing thereof. For example, the pictogram relating to the imminent opening of a door of the vehicle may be formed of a sequence of images depicting a door opening.

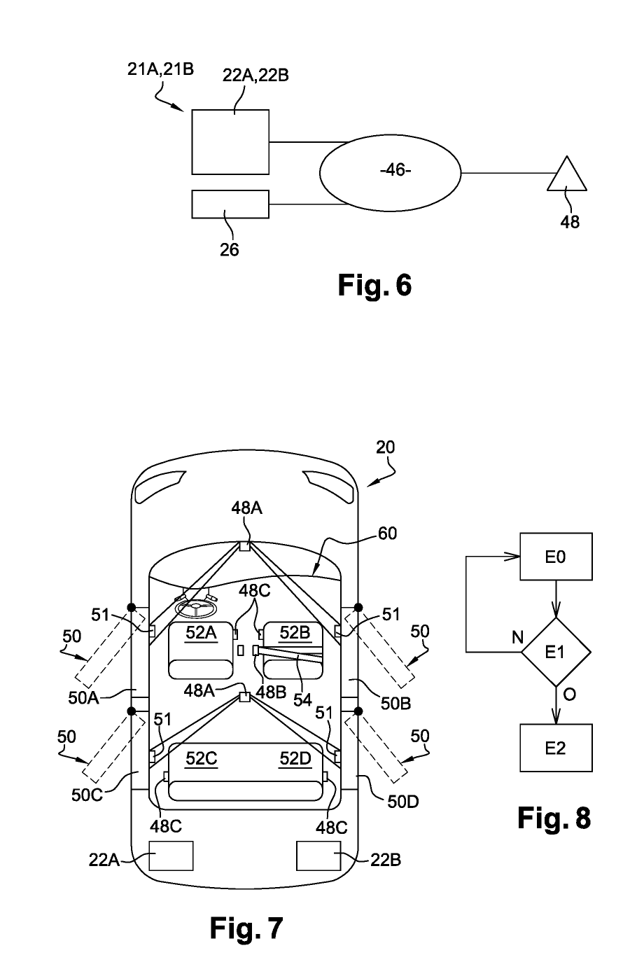

One exemplary embodiment of the signalling device 21A, 21B and of the operation thereof is illustrated in FIG. 6. In addition to the display means 22A, 22B, the signalling device 21A, 21B in this case comprises an electronic control unit 46 and sensors 48 on board the vehicle 20. The sensors 48 are configured to detect or calculate certain parameters. All of these sensors 48 are linked to the electronic control unit 46 so as to provide these parameters to it.

The electronic control unit 46 is configured to automatically control the display of a pictogram representative of a determined situation on the basis of the parameters measured by the sensors 48. To this end, it develops display orders that it transmits to the display means 22A, 22B.

The electronic control unit 46 includes for example a memory in which a list of predetermined pictograms is stored. The electronic control unit 46 selects the program to be displayed from the pictogram list on the basis of the situation. It may also dynamically change the design of the pictogram on the basis of these parameters.

In the corresponding embodiment, the electronic control unit 46 also sends commands to the additional means 26 so as to coordinate them with the display means 22A, 22B for displaying the pictogram. Thus, the pictogram beam and the additional beam are coordinated so as to fulfil the regulatory photometric characteristics.

In the case of a pair of signalling devices 21A, 21B, each display means 22A, 22B is able to be controlled independently of one another by the electronic control unit 46.

According to the teaching of the invention, the display means 22A, 22B described above are used to warn third parties, for example pedestrians or bicycles, of the imminent opening of a door of the vehicle 20 by automatically displaying the pictogram 40 representative of the imminent opening of a door of the vehicle.

FIG. 7 shows a schematic plan view of the passenger compartment of the vehicle 20. This is a motor vehicle 20.

The passenger compartment is in this case closed by doors 50, and more particularly by two front doors 50A, 50B and two rear doors 50C, 50D.

Each door 50A, 50B, 50C, 50D includes an interior control element for opening the doors, which is in this case formed for example by an associated interior handle 51 intended to actuate the opening of the associated door.

As a variant, the interior control element for opening a door is formed by a switch arranged at a distance from the door, for example a touchscreen or a button arranged on the dashboard of the vehicle.

Each door 50 is adjacent to a seat 52 of the vehicle 20. Each seat 52A, 52B, 52C, 52D is in this case formed by a seat cushion.

Each seat 52A, 52B, 52C, 52D is in this case equipped with a safety belt 54, only the safety belt of the front right-hand seat 52B being shown for the sake of clarity.

The vehicle 20 illustrated in FIG. 7 also incorporates a display system 60 produced according to the teaching of the invention. The display system 60 comprises:
a display means 22A, 22B comprising a display area 24A, 24B intended to be arranged on the vehicle 20 so as to be visible to third parties outside the vehicle;
at least one device for detecting parameters representative of the imminent opening of a door 50 of the vehicle 20;
an electronic control unit for controlling the display means 22A, 22B and that is connected to the detection device and to the display means 22A, 22B in order to be able to control the display of a pictogram representative of the imminent opening of a door 50 of the vehicle 20 on the basis of the detected parameters representative of the opening of a door 50 of the vehicle 20.

The device(s) for detecting parameters representative of the imminent opening of a door 50 of the vehicle 20 are chosen from the following list:
a speed sensor of the vehicle 20;
a manual control element for turning off an engine of the vehicle;
a timer measuring the time that has elapsed starting from the turning off of the engine of the vehicle;
a sensor 48B for sensing the presence of a hand of an occupant of the vehicle 20 close to or in contact with an interior control element 51 for opening a door 50;
a device for detecting the buckle state of a safety belt 54 fitted in the vehicle 20;
a sensor for sensing the presence of an occupant on a seat 52 of the vehicle 20;
a geolocation device of the vehicle 20;
an automatic parking assistance device of the vehicle 20. With reference to the block diagram of FIG. 8, the method includes a first step “E1” of determining the imminent opening of a door 50 of the vehicle, during which the electronic control unit 46 checks that one or more parameters representative of the imminent opening of a door 50 of the motor vehicle 20 fulfil predetermined conditions. The parameters are measured by detection devices formed by appropriate sensors 48 in a step “E0” prior to step “E1”.

When the predetermined conditions are fulfilled, a second step “E2” of developing a display order is automatically triggered. During this second step “E2”, the electronic control unit 46 emits an order to display a pictogram 40 representative of the imminent opening of a door 50 of the vehicle 20 on at least one of the display means 22A, 22B.

There is provision for the pictogram 40 representative of the imminent opening of a door 50 of the vehicle 20 to remain displayed on the display means in question until a door 50 has been closed again and/or for a predetermined display duration.

According to a first embodiment of the method, a parameter representative of the imminent opening of a door 50 of the vehicle 20 is formed by the parking state of the vehicle 20.

In this first embodiment, an associated condition “C1” to be fulfilled in the first step “E1” is for the engine to change from the turned-on state to the turned-off state. Specifically, when the driver turns the engine off, it is highly probable that one of the occupants of the vehicle 20 will open an associated door 50 in order to get out within a relatively short time.

This parameter is detected for example by the actuation of a manual control element, activated by the driver, for turning off the engine. This involves for example turning a contact key or, in the case of vehicles 20 without a contact key, actuating a manual control element such as a button.

As a variant, the condition for turning off the engine is fulfilled when the driver removes the contact key.

According to one variant of this first embodiment, this first condition “C1” relating to the parking state of the vehicle 20 may be supplemented by a second condition “C2” formed by a time delay being reached or exceeded, starting from the turning off of the engine of the vehicle, as measured for example by a timer. Thus, a second parameter representative of the imminent opening of a door 50 of the vehicle 20 is formed by the time that has elapsed since the turning off of the engine. The second step “E2” of developing the display order is then triggered only when the two conditions “C1” and “C2” are fulfilled at the same time.

In this first embodiment, the parameters chosen to detect the imminent opening of a door 50 of the vehicle 20 do not make it possible to detect the side of the vehicle 20 on which a door 50 will open. In this case, the electronic control unit 46 emits a simultaneous display order to the display means 22A, 22B of the two signalling devices 21A, 21B so as to attract the attention of third parties approaching the motor vehicle 20 from the right-hand side and from the left-hand side.

As a variant, the display order will be sent only to the display means 22A situated on the side of the driver, or to the means situated on the driver side when the vehicle includes display means arranged on the side or at the front of the vehicle.

This first embodiment makes it possible to achieve the display of the appropriate pictogram 40 when there is a strong probability of the doors 50 being opened.

According to a second embodiment of the method, the second step “E2” is triggered when a parking state condition of the vehicle 20 and at least one additional condition are fulfilled in combination. In comparison with the first embodiment, the method carried out according to this second embodiment thus makes it possible to reduce the probability of false alarms, that is to say of displaying the pictogram 40 representative of the imminent opening of a door 50 of the vehicle 20 without this being followed by the effective opening of a door 50.

The first step “E1” includes checking at least one of the following parking state conditions of the vehicle 20:
the first parking state condition “C1” is that the engine of the vehicle 20 is turned off; and/or
the second parking state condition “C3” is that the speed of the vehicle 20 is zero.

To determine the first parking state condition “C1”, reference will be made to the description of the first embodiment.

For the parking state condition “C3” relating to the zero speed of the vehicle 20, the speed parameter of the vehicle 20 is measured by a speed sensor (not shown) of the vehicle 20. This is for example a speed sensor used to indicate the current speed of the vehicle 20 to the driver through a display on the dashboard.

Specifically, it is unlikely that the door 50 of the vehicle 20 will be opened when the vehicle 20 is moving. Furthermore, the untimely displaying of the pictogram 40 representative of the imminent opening of a door 50 of the vehicle 20 while the vehicle 20 is moving risks disrupting the road users following the vehicle 20.

Taking into account one of the parking state conditions “C1” or “C3” taken alone makes it possible to determine a situation in which an occupant of the vehicle 20 is liable to open a door 50 imminently.

In order to be able to determine the imminent opening of a door 50 of the vehicle 20 with greater accuracy, at least one of these first parking state conditions “C1” and/or “C3” of the vehicle 20 is combined with at least one of the following additional conditions, such that the second step “E2” of the method is triggered.

A first additional condition “C4” to be fulfilled, in combination with at least one of the parking state conditions “C1” and/or “C3”, is that a hand is detected close to or in contact with an interior control element for opening the door 50 of the vehicle 20. This parameter is detected by at least one presence sensor 48A arranged in the vehicle 20.

Advantageously, the presence sensor(s) 48A are able to identify the door 50 of the motor vehicle 20 that is going to be opened. This is for example the case when the internal opening control element is formed by an interior handle 51 that is individually associated with a door 50.

As a variant, the invention is able to be applied to remote internal opening control elements formed by one or more switches controlling the opening of one or more doors.

In a first variant embodiment, this is a proximity sensor 48A that detects the hand of an occupant of the vehicle 20 a short distance away from the internal control element for opening the door, before this hand touches it.

The proximity sensor 48A is for example formed by at least one camera arranged inside the vehicle 20, for example on the ceiling at the central rear-view mirror. This camera 48A makes it possible to detect the presence of a mobile element, in particular the hand of an occupant, close to the interior handle 51 of each of the two front doors 50A, 50B, for example using image analysis means.

In the example shown in FIG. 7, a second camera 48A is arranged on the ceiling between the two rear doors 50C, 50D so as to be able to detect the approach of the hand of an occupant towards an interior handle 51 of said rear doors 50C, 50D.

According to one variant, not shown, the proximity sensor is formed by a capacitive sensor or else by an infrared sensor. In this case, each door of the vehicle is advantageously equipped with an associated proximity sensor.

According to a second variant, not shown, of this embodiment, the presence sensor is formed by a contact sensor that is arranged in the interior handle 51 of each door 50 of the vehicle 20 and that detects contact of a hand on the interior handle 51. This is for example a pressure sensor.

As a variant, the presence sensors are arranged so as to detect the approach or contact of a hand on an interior handle for only some of the doors 50 of the vehicle, for example the front doors 50A, 50B or the rear doors 50C, 50D.

In any case, when at least one of the parking state conditions “C1”, “C3” and the additional condition “C4” of detecting a hand close to the interior handle of a door 50 are fulfilled, the second step “E2” is triggered.

This condition of detecting a hand close to the interior handle makes it possible to identify the side of the vehicle 20 on which a door 50 will open. The electronic control unit 46 advantageously emits a display order to the display means of the signalling device 21A, 21B situated on the side of said door 50 about to be opened so as to attract the attention of third parties approaching the side thereof.

A second additional condition “C5” relates to the parameter formed by the buckle state of a safety belt 54. This second additional condition “C5” is that the safety belt 54 changes from a buckled state to an unbuckled state.

To this end, the safety belts 54 of the motor vehicle 20 are provided with associated sensors 48B, which are already well known in the context of safety devices that ensure that the occupants of the motor vehicle 20 are correctly secured when the motor vehicle 20 begins to move.

Advantageously, all of the safety belts 54 fitted to one of the seats 52 adjacent to a door 50 are equipped with such a sensor 48B.

When at least one of the state conditions “C1”, “C3” of the vehicle 20 and the second additional condition “C5” are combined, the second step “E2” of the method is triggered, during which the electronic control unit 46 emits an order to display the pictogram 40 representative of the imminent opening of a door 50 of the vehicle 20 on the side corresponding to the side on which the safety belt 54 has been detected as being unbuckled by the sensor 48B.

A third additional condition “C6” relates to the parameter formed by the detection of a passenger on his seat 52. This third additional condition “C6” is fulfilled when the presence of a weight, presumed to be a person, greater than a determined threshold is detected on at least one of the seats 52 of the vehicle 20.

To measure this parameter, the cushion of at least one of the seats of the vehicle 20 is equipped with a weight sensor 48C. Advantageously, each seat of the vehicle 20 is individually equipped with such a weight sensor 48C. A plurality of sensors 48C are fitted in the vehicle 20 so as to ensure that all of the vehicle 20 occupants have buckled their safety belt 54.

This third additional condition “C6” advantageously makes it possible to detect the seats 52 of the vehicle 20 that are occupied. This makes it possible in particular to display the pictogram 40 for imminent opening of a door 50 on the two signalling devices 21A, 21B when the seats 52 are occupied on both sides of the vehicle 20, or else to display the pictogram 40 on the side corresponding to the seats 52 that are occupied when the seats situated on the other side of the vehicle 20 are unoccupied.

A fourth additional condition “C7” relates to the parameter formed by the locking state of the lock (not shown) of at least one door 50. This fourth associated condition is fulfilled when the lock of at least one door 50 changes from a locked state to an unlocked state.

For a motor vehicle 20 equipped with independent locking latches for each door 50, this fourth condition “C7” also makes it possible to identify the door 50 of the vehicle 20 that is unlocked.

By contrast, when the vehicle 20 is equipped with a central locking device, this fourth condition “C7” has to be associated with at least one of the other additional conditions “C4” to “C6” in order to make it possible to identify the side on which the door 50 will open.

When the vehicle is equipped with a geolocation device (not shown) that includes a user interface by way of which the driver is able to enter at least one destination determined by the driver, a fifth associated condition “C8” to be fulfilled in the first step “E1” is that the vehicle has reached the determined destination.

Such geolocation devices are better known under their acronym GPS for global positioning system. These well-known devices allow the user to enter a destination to be reached, the geolocation device then making it possible to establish a path for guiding the driver to his destination.

Such a device also allows the driver to enter common stored destination addresses, such as a home address.

A parameter representative of the imminent opening of a door 50 of the vehicle 20 is thus formed by the geographical location, detected by the geolocation device, of the vehicle. When the vehicle reaches a destination following guidance, or else when the vehicle is parked close to an address stored in the memory of the geolocation device, the condition “C8” is considered to be fulfilled.

Some vehicles 20 are equipped with an automatic parking assistance device (not shown). This makes it possible to control the drive train of the vehicle automatically in order to park the vehicle in a space detected by obstacle detection systems such as radars, lidars or else cameras.

A parameter representative of the imminent opening of a door 50 of the vehicle 20 is formed by the actuation of the parking assistance device. The associated condition “C9” to be fulfilled in the first step “E1” is that the parking assistance device has been actuated. For example, at the end of parking by actuation of the parking assistance device, when the vehicle is stationary in its parking space.

The invention covers the alternate or cumulative combination of the various parking conditions “C1” and/or “C3” with at least one of the additional conditions “C4” to “C9”.

A few exemplary combinations of conditions “C1” to “C9”, able to be used by the method carried out according to the teaching of the invention, will be given hereinafter without limitation.

According to a first exemplary implementation of this second embodiment, the first step “E1” of the method consists in checking that the following two conditions are fulfilled in combination in order to be able to trigger the second step “E2”:
one of the parking state conditions “C1” or “C3” of the vehicle 20, for example the zero speed condition “C3”, and
the condition “C4” of detecting a hand close to the interior handle of the vehicle 20.

This combination makes it possible to detect the side(s) on which a door 50 will open.

According to a second exemplary implementation of the second embodiment of the invention, in order to acquire a more accurate estimation of the imminent opening of the door 50 of the vehicle 20, the first step “E1” of the method consists in checking that the following three conditions are fulfilled in combination in order to be able to trigger the second step “E2”:
one of the parking state conditions “C1” or “C3” of the vehicle 20, for example the zero speed condition “C3”, and
the condition “C4” of detecting a hand close to the interior handle of the vehicle 20; and
the additional condition “C5” of the safety belt 54 changing from the buckled state to the unbuckled state.

This makes it possible to avoid false alarms, for example when the hand of an occupant inadvertently passes close to the interior handle of a door 50. The addition of the condition “C5” regarding the safety belt makes it is possible to focus more particularly on the doors 50 on the side of which an occupant is ready to get out.

According to a third exemplary implementation of the second embodiment of the invention, the first step “E1” of the method consists in checking that the following four conditions are fulfilled in combination in order to be able to trigger the second step “E2”:
one of the parking state conditions “C1” or “C3” of the vehicle 20, for example the zero speed condition “C3”, and
the condition “C4” of detecting a hand close to the interior handle of the vehicle 20; and
the condition “C6” of detecting occupation of certain seats 52; and
the condition “C5” relating to the fact that the safety belt 54 of at least one of the occupied seats 52 is not buckled.

This variant makes it possible to take into account the case of occupants of the vehicle 20 not having secured their safety belt 54, these occupants thus being ready to get out of the vehicle 20.

According to a fourth exemplary implementation of the second embodiment of the invention, the first step “E1” of the method consists in checking that the following two conditions are fulfilled in combination in order to be able to trigger the second step “E2”:
one of the parking state conditions “C1” or “C3” of the vehicle 20, for example the zero speed condition “C3”, and
the additional condition “C5” of the safety belt 54 changing from the buckled state to the unbuckled state.

This fourth example, which is a simplified version of the second example, is particularly suitable for vehicles 20 without a sensor 48B for sensing the presence of a hand close to or in contact with the interior handle of the door 50.

Of course, these four examples are nonlimiting, and other combinations of the conditions described above may be contemplated.

There may also be provision not to apply the method to doors 50 of which a safety system, called “child safety”, for preventing opening by way of the interior handle, is activated.

The method will be more effective, for example by triggering fewer false alarms, when the first step “E1” includes a large number of conditions to be fulfilled in combination in order to be able to trigger the second step “E2”.

However, it is also possible to contemplate simplified versions of the method, such as described for example in the first embodiment or in the fourth example of the second embodiment, in particular when the vehicle 20 is not equipped with appropriate sensors for checking that other additional conditions are met.

The method carried out according to the teaching of the invention thus makes it possible to warn third parties of the imminent opening of a door 50 of the vehicle 20. This allows third parties to anticipate the opening of a door 50, independently of the vigilance of the occupant opening said door 50.

The method applied to the signalling device 21A, 21B described above makes it possible to display a pictogram 40 that complies with the regulatory obligations in respect of signalling lights. Thus, when the stop lights or the position lights of the vehicle 20 are turned on, the pictogram 40 contributes to, or even completely produces, said regulatory function.

Furthermore, some embodiments of the method make it possible to indicate the side on which a door 50 will open, so as to selectively display the pictogram 40 representative of the imminent opening of a door 50 of the vehicle 20 on said side.

In the variant embodiment in which the vehicle includes a single display means arranged at the rear of the vehicle, a single display means receives the display order.

When the motor vehicle includes at least one display means that is arranged on the side and/or at the front of the vehicle, the display means are controlled either simultaneously or on the basis of the side on which the door opens, when this is possible. This thus makes it possible to warn third parties who are approaching from in front of the vehicle or who are already level with the vehicle of the imminent opening of a door of the vehicle 20.

1. Method for controlling a display means on board a motor vehicle, the display means including a display area visible from outside the vehicle, the display means being configured to selectively display each of the pictograms from a list of a plurality of predetermined pictograms, each predetermined pictogram being representative of a determined situation,
wherein the method includes:
a first step of determining the imminent opening of a door of the vehicle, during which it is checked that at least one parameter representative of the imminent opening of a door of the motor vehicle fulfils at least one predetermined condition,
a second step of developing a display order that is triggered when the predetermined conditions are fulfilled, and during which an order to display a pictogram representative of the imminent opening of a door of the vehicle on the display means is emitted by an electronic control unit.

2. Method according to claim 1, wherein a first parameter representative of the imminent opening of a door of the vehicle is formed by the speed of the vehicle, an associated condition to be fulfilled in the first step being that the speed of the vehicle is zero.

3. Method according to claim 1, wherein a second parameter representative of the imminent opening of a door of the vehicle is formed by the operating state of the engine of the vehicle, an associated condition to be fulfilled in the first step being that the engine changes from the turned-on state to the turned-off state.

4. Method according to claim 3, wherein a third parameter representative of the imminent opening of a door of the vehicle is formed by the time that has elapsed since an engine of the vehicle was turned off, an associated condition to be fulfilled in the first step being that a time delay has been exceeded, starting from the turning off of the engine of the vehicle.

5. Method according to claim 1, wherein the motor vehicle includes a sensor for sensing the presence of a hand of an occupant of the vehicle close to or in contact with an interior control element for opening the door, a fourth parameter representative of the imminent opening of a door of the vehicle being formed by the presence of a hand close to or in contact with the interior opening control element, an associated condition to be fulfilled in the first step being the presence of a hand close to the interior opening control element being detected.

6. Method according to claim 5, wherein the presence sensor is formed by at least one camera.

7. Method according to claim 5, wherein the presence sensor is formed by at least one infrared sensor arranged close to the interior opening control element.

8. Method according to claim 5, wherein the proximity sensor is formed by at least one capacitive sensor arranged close to the interior opening control element.

9. Method according to claim 1, wherein a parameter representative of the imminent opening of a door of the vehicle is formed by the buckle state of a safety belt fitted in the vehicle, an associated condition to be fulfilled in the first step being that the safety belt changes from a buckled state to an unbuckled state.

10. Method according to claim 1, wherein a parameter representative of the imminent opening of a door of the vehicle is formed by the detection of an occupant on his seat, an associated condition to be fulfilled in the first step being that a weight greater than a determined threshold is detected on said seat.

11. Method according to claim 1, wherein a parameter representative of the imminent opening of a door of the vehicle is formed by the locking state of a lock of at least one door, an associated condition to be fulfilled in the first step being that the lock of at least one door changes from a locked state to an unlocked state.

12. Method according to claim 1, wherein the vehicle is equipped with a geolocation device into which the driver is able to enter at least one destination determined by the driver, a parameter representative of the imminent opening of a door of the vehicle being formed by the geographical location, detected by the geolocation device, of the vehicle, an associated condition to be fulfilled in the first step being that the vehicle has reached the determined destination.

13. Method according to claim 1, wherein the vehicle is equipped with an automatic parking assistance device, a parameter representative of the imminent opening of a door of the vehicle being formed by the actuation of the parking assistance device, an associated condition to be fulfilled in the first step being that the parking assistance device has been actuated.

14. Method according to claim 5, wherein the motor vehicle includes two display means that are each arranged on a side of the vehicle, at least one of the parameters representative of the imminent opening of a door of the vehicle being able to detect the side on which the door whose opening is imminent is situated, the display order developed in the second step being sent only to the display means arranged on the same side as said door whose imminent opening was detected in the first step.

15. Method according to claim 1, wherein the rear of the motor vehicle includes a single display means.

16. Method according to claim 1, wherein the motor vehicle includes at least one display means that is arranged on the side and/or at the front of the vehicle.

17. System for displaying at least one pictogram on a motor vehicle, comprising:
a display means comprising a display area intended to be arranged on the vehicle so as to be visible from outside the vehicle;
at least one device for detecting parameters representative of the imminent opening of a door of the vehicle;
an electronic control unit for controlling the display means and that is connected to the detection device and to the display means in order to be able to control the display of a pictogram representative of the imminent opening of a door of the vehicle on the basis of the detected parameters representative of the opening of a door of the vehicle.

18. Display system according to claim 17, wherein each device for detecting parameters representative of the imminent opening of a door of the vehicle is chosen from the following list:
a speed sensor of the vehicle;
a manual control element for turning off an engine of the vehicle;
a timer measuring the time that has elapsed starting from the turning off of the engine of the vehicle;
a sensor for sensing the presence of a hand of an occupant of the vehicle close to or in contact with an interior control element for opening a door;
a device for detecting the buckle state of a safety belt fitted in the vehicle;
a sensor for sensing the presence of an occupant on a seat of the vehicle;
a geolocation device of the vehicle;
an automatic parking assistance device of the vehicle.

19. Motor vehicle comprising a display system according to claim 17.

20. Method according to claim 2, wherein a second parameter representative of the imminent opening of a door of the vehicle is formed by the operating state of the engine of the vehicle, an associated condition to be fulfilled in the first step being that the engine changes from the turned-on state to the turned-off state.
